(19) United States
(12) Patent Application Publication
(10) Pub. No.: US 2012/0123884 A1
(43) Pub. Date: May 17, 2012

(54) Store management via remote point of sale data management system

(76) Inventor: Harinder Pal Singh Bhasin, Danville, CA (US)

(21) Appl. No.: 12/927,460

(22) Filed: Nov. 16, 2010

(51) Int. Cl. G06Q 10/00

(52) U.S. Cl. 705/21

(57) ABSTRACT

The present invention provides a method and system for accessing and managing business data stored in a POS system through a mobile device. The method enables a remote user to access and manage the business data present on the POS system in real time and effectively manage a store. The business data is provided to the user based on ad-hoc requests or automatic data feeds. The method includes receiving a request for the business data from the mobile device and converting the request to a first format, retrieving the requested business data from the POS system according to predefined rules and policies, converting the retrieved data to a second format, and transmitting the converted business data to the mobile device. The invention also includes providing the business data automatically to the mobile device based on predefined rules and policies.

### FIELD OF THE INVENTION

The present invention relates in general to management of Point of Sale (POS) data. More particularly, the invention relates to a system, method and computer program product for managing data of a Point of Sale (POS) system from a remote location.

### BACKGROUND

Management of business data in retail stores such as gas stations, restaurants, provision stores, pubs, and the like, is a very important and complex task. The business data may include, for example, sales figures, inventory details, ongoing schemes, login details of employees, and sales averages. This business data needs to be accessed and monitored in real time by the management of the retail stores to streamline the functioning of the retail stores. POS systems provide an efficient way of managing the business data. The POS systems reduce the manual intervention in business data management and help in improving customer satisfaction by reducing the time required for retail transactions. Further, the POS systems enable a user to store the business data for future reference.

Existing POS systems include one or more POS terminals and one or more POS data servers. The POS terminals act as the user interface for capturing and modifying the business data. This business data is downloaded on the POS data servers and may be stored for future reference. Further, some of the existing POS systems also facilitate management of the business data from a remote location by providing portable POS terminals.

However, the existing POS systems do not provide a real time remote access to the business data present on the POS servers. The existing POS systems with portable POS terminals work over a limited geographical area as defined by the configuration of the POS systems. Further, the POS terminals are bulky and entail costly infrastructure.

In light of the foregoing, there is a need for a system that facilitates access to the business data of a POS system from a remote location and can be used with the existing POS systems without entailing costly infrastructure. Further, there is a need for a POS system which can enable a remote user to receive real time updates about the developments in the retail store.

### SUMMARY

An object of the invention is to provide an effective method, system and computer program product for facilitating effective store management through real time data management for POS system data.

Another object of the invention is to provide an effective POS data management system that enables real time access to the POS data.

Yet another object of the invention is to provide an effective remote POS data management system that does not entail costly infrastructure.

Still another object of the invention is to provide effective store management.

Embodiments of the invention provide a method for facilitating management of a remote Point of Sale (POS) terminal by using a mobile device. A request for POS data is received at an application server. The POS data corresponding to the request is retrieved from a database. Further, the POS data is converted into a mobile readable data format and sent to the mobile device.

Embodiments of the invention provide a system for facilitating management of a Point of Sale (POS) terminal by using a mobile device. The system comprises a database for storing POS data and an application server which is in communication with the POS terminal, the database and the mobile device. The application server comprises a mobile device transport server for receiving a request for POS data, a database manager for retrieving the POS data corresponding to the request, and a mobile content manager for converting the retrieved POS data to a mobile readable format and sending it to the mobile device.

Embodiments of the invention provide a computer program product for facilitating management of a remote Point of Sale (POS) terminal by using a mobile device. The computer program product includes program instructions for receiving a request for POS data, program instructions for retrieving the POS data corresponding to the request from a database, program instructions for converting the POS data into a mobile readable data format and program instructions for sending the converted data to the mobile device.

### BRIEF DESCRIPTION OF THE DRAWINGS

Various embodiments of the invention will hereinafter be described in conjunction with the appended drawings, provided to illustrate and not to limit the invention, wherein like designations denote like elements, and in which:

FIG. 1 illustrates a system for remote POS data management, in accordance with an embodiment of the invention;

FIG. 2 illustrates various components of an application server for connecting a mobile device with a POS system, in accordance with an embodiment of the invention;

FIG. 3a and FIG. 3b are exemplary screenshots illustrating a process for initiating a request for business data using a mobile device, in accordance with an embodiment of the invention;

FIG. 3c is an exemplary screenshot of a user interface for displaying the business data retrieved from a POS system on a mobile device, in accordance with an embodiment of the invention;

FIG. 4 is a flowchart of a method for providing business data to a mobile device, in accordance with an embodiment of the invention; and

FIG. 5 is a flow chart of a method for providing business data to a mobile device, in accordance with another embodiment of the invention.

### DETAILED DESCRIPTION OF THE INVENTION

The present invention provides a method and system for accessing and managing business data stored in a POS system through a mobile device. The method enables a mobile user to access and manage the business data present on the POS system in real time. The business data may be provided to the user based on ad-hoc requests or automatically based on the predefined subscription models.

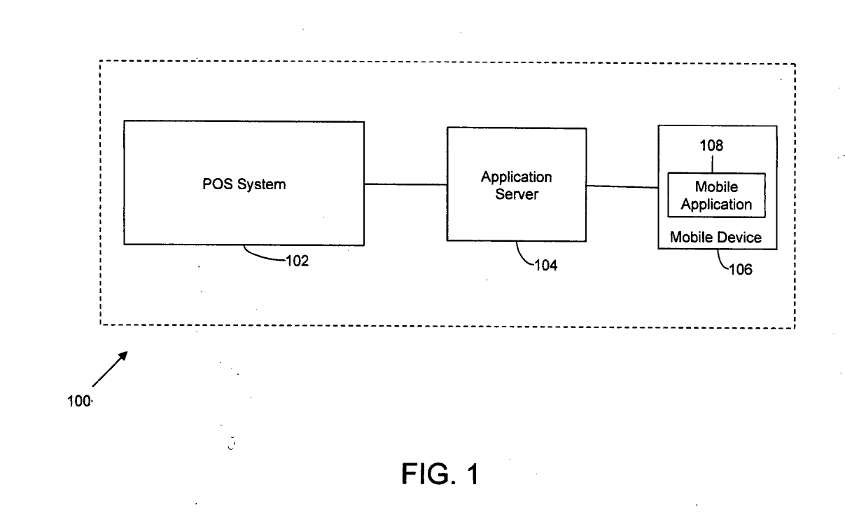

FIG. 1 illustrates a system 100 for remote POS data management, in accordance with an embodiment of the invention. System 100 includes a POS system 102, an application server 104 and a mobile device 106. A user can access and manage the business data present on POS system 102 through mobile device 106. Application server 104 enables the connectivity between POS system 102 and mobile device 106. FIG. 1 is given as an exemplary figure to illustrate the connection and interaction between one POS system, one application server and one mobile device for simplicity and clarity. However, the invention should not be considered limited to interaction between one POS system, one application server and one mobile device only. The presentation invention includes interaction between multiple POS systems, multiple application servers and multiple mobile devices. For example, such an interaction is achieved by using POS systems, application servers, and mobile devices in the cloud computing environment.

POS system 102 contains one or more POS terminals and one or more POS data servers. The POS terminals act as the user interface for capturing and modifying the business data, and the POS data servers are used to store the data for future reference. In an embodiment of the present invention, one or more POS systems can be implemented in the Cloud Computing architecture. Therefore, one or more data servers in the cloud store the business data. One or more POS terminals are used to access and modify the stored business data on one or more servers on the cloud. The business data may include, for example, sales figures, inventory details, ongoing schemes, login details of employees, and sales averages for the retail store. The business data may be stored in a predefined format that may include, for example, text files, data tables, numbers, combinations thereof, and the like. In accordance with various embodiment of the invention, POS system 102 is a conventional POS system for the retail stores.

Application server 104 is connected to POS system 102 and to mobile device 106, and retrieves the business data from POS system 102. This includes, for example, retrieving only the specific fields from the business data present on POS system 102. The business data may also be stored within application server 104 for future reference. In accordance with another embodiment of the invention, application server 104 may screen the business data stored within a local database present on application server 104 and retrieve the requested business data.

In accordance with an embodiment of the invention, application server 104 retrieves the business data based on an ad-hoc request from mobile device 106. Mobile device 106 may contain a mobile application 108 which is used to initiate the request from mobile device 106. Further, mobile application 108 may assist in enabling the connection between mobile device 106 and application server 104. In accordance with another embodiment of the invention, application server 104 retrieves the business data from POS system 102 regularly, based on predefined policies and rules. Application server 104 may store the retrieved data for future reference. In particular, the business data stored within application server 104 may be overwritten regularly, for example, with each regular update to keep only the most recent data. For example, application server 104 may be configured to retrieve selected business data from POS system 102 at regular intervals. In accordance with an embodiment of the invention, application server 104 and POS system 102 are connected through a connection link. The connection link may be a wired or wireless system based on, for example, internet proxies, an IP connection, a direct link, and the like. In another embodiment of the invention, one or more application servers 104 and one or more POS systems 102 are cloud components in a cloud computing environment that communicate with each other over application programming interfaces. The cloud computing environment enables multiple mobile devices, such as mobile device 106, to access data stored in multiple POS systems 102 in the cloud. The business data retrieved from POS system 102 is converted into a mobile compatible format and transmitted to mobile device 106. Examples of the mobile compatible format may include text messages, multimedia messages, pictures, audio messages, video messages, and the like. In accordance with an embodiment of the invention, application server 104 may transmit the retrieved data to mobile device 106 as a response to an ad-hoc request. In accordance with another embodiment of the invention, application server 104 may be configured to retrieve business data and transmit the retrieved data to mobile device 106 automatically, without explicit mobile request, based on predefined rules and policies.

Examples of the predefined rules may include: a rule to send a message to mobile device 106 every hour such that the message contains the details of net sales for that hour; a rule to send a message to mobile device 106 every time an employee login or logout occurs; a rule to send a message to mobile device 106 every hour between a specified time period about the employee login details; a rule to send a message to mobile device 106 in case stock of an item falls below a pre-specified level; a rule to send a message to mobile device 106 in case the net sales is less than a specified amount for three consecutive hours; and the like.

Examples of mobile device 106 may include a laptop, a mobile phone, a Personal Digital Assistant (PDA), a Smartphone, and the like. Examples of mobile application 108 may include java based applications, executable files, and the like. Mobile device 106 may be connected to application server 104 through a mobile communication link. Examples of the mobile communication link may include a Bluetooth connection, an Infra-red connectivity, a Wi-Fi connection, an Internet Protocol (IP) link, a Transmission Control Protocol (TCP) link, a transmission Control Protocol/Internet Protocol (TCP/IP) link, a Wireless Application Protocol (WAP) link, Global System for Mobile (GSM) link, a Time Division Multiple Access (TDMA) link, a Code Division Multiple Access (CDMA) link, 2G and 3G standards based link, and the like.

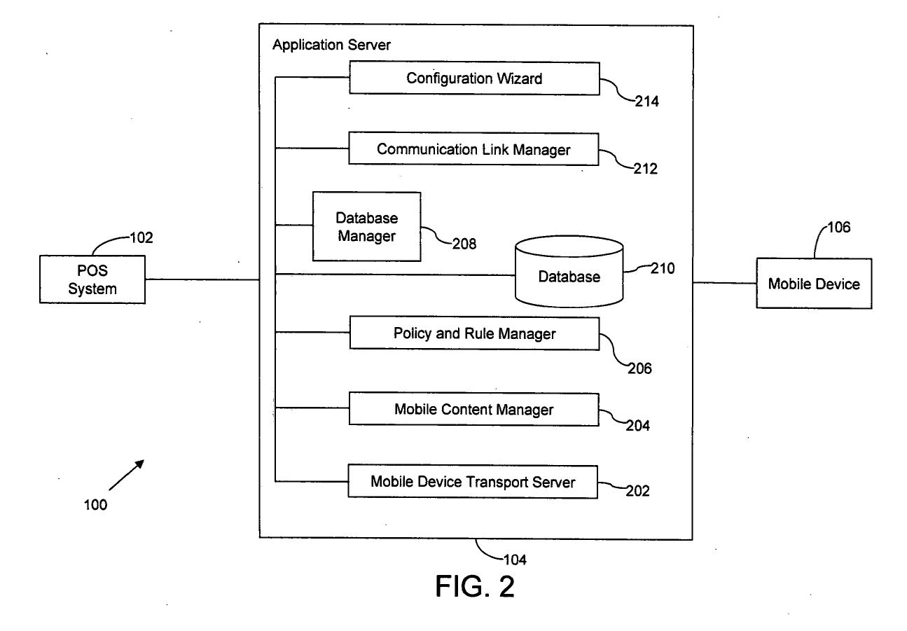

In accordance with an embodiment of the invention, application server 104 may retrieve business data from more than one POS systems similar to POS system 102. Application server 104 may also be configured to collate the business data from more than one POS systems before providing the business data to mobile device 106. In accordance with an embodiment of the invention, application server 104 may also be configured to interact with more than one mobile device similar to mobile device 106. The structure and functioning of application server 104 is described in detail in conjunction with FIG. 2.

In accordance with an embodiment of the invention, a request from one or more mobile devices 106 may also be used to modify business data on one or more POS systems 102. One or Mobile devices 106 may access and modify the business data on one or more POS systems 102 in a cloud computing environment or otherwise connected together using other known connections. For example, the request may contain instructions to update a field such as inventory details on POS system 102 using mobile device 106. The request from mobile device 106 is converted to a first format readable by database manager 208 of FIG. 2 and POS system 102, and may be used to update specific fields in the business data.

FIG. 2 illustrates various components of application server 104 for enabling remote POS data management, in accordance with an embodiment of the invention. Application server 104 contains a mobile device transport server 202, a mobile content manager 204, a policy and rules manager 206, a database manager 208, a database 210, a communication link manager 212 and a configuration wizard 214. The components shown in FIG. 2 may be software, hardware or a combination of software and hardware.

Mobile device transport server 202 connects application server 104 to a mobile device such as mobile device 106, and receives a request for business data from mobile device 106. Mobile content manager 204 converts the request into a first format and forwards the converted request to database manager 208. Examples of the first format may include text, numbers, pointers, and the like. In accordance with various embodiments of the invention, the first format facilitates decoding of the request by the components such as database manager 208, policy and rules manager 206, and the like.

Database manager 208 is connected to database 210 and keeps track of the business data available on database 210. Upon receiving the request, database manager 208 checks if the data is available in database 210. If the data is available in database 210, database manager 208 initiates the retrieval of the requested data in conjunction with policy and rules manager 206.

Database 210 contains the business data retrieved from POS system 102 and subscription details of different users requesting the business data through one or more mobile devices similar to mobile device 106. If the requested data is available in database 210, database manager 208 retrieves the requested data from database 210. This retrieval is facilitated by policy and rules manager 206 by executing different policies and rules related to, for example, authorizing the request based on the subscription model of mobile device 106, screening the business data stored in database 210 to identify the requested data, and the like. For example, the authorization of a request may be performed by matching the phone number of mobile device 106 with the phone number(s) provided by the user (subscriber) during subscription. Further, the authorization may also be performed by prompting mobile device 106 for user logins when a request for business data is received by application server 104.

When the requested data is not available with database 210, database manager 208 initiates the retrieval of requested data from one or more POS systems 102 in conjunction with policy and rules manager 206. Based on the subscription model of mobile device 106, policy and rules manager 206 facilitates the retrieval of the requested data from database 210 through communication link manager 212.

The business data retrieved from one or more POS systems 102 is sent to database manager 208. Database manager 208 may facilitate storage of a copy of the retrieved business data in database 210 and provides the retrieved data to mobile content manager 204. Policy and rules manager 206 provides the details of a second format readable by mobile device 106 based on, for example, subscription model, category of mobile device, information provided in the request, nature of requested data, and the like. The information regarding the second format is also provided to mobile content manager 204 along with the requested data retrieved by database manager 208.

Mobile content manager 204 converts the retrieved data to the second format and provides the converted data to mobile device transport server 202. Examples of the second format may include a short messaging service (SMS), a Multimedia messaging services (MMS), a picture message, a really simple syndication (RSS feed), and the like. Mobile device transport server 202 typically transmits the retrieved data to mobile device 106 in data packet encapsulated in IP Protocol (TCP/UDP).

Examples of mobile device transport server 202 may include IP connection handler, SMS handler, and the like. Mobile device transport server 202 may be connected to mobile device 106 through a communication link which may include, for example, a wireless internet link including a Bluetooth connection, an Infra-red connectivity, a Wi-Fi connection, an Internet Protocol (IP) link, a Transmission Control Protocol (TCP) link, a transmission Control Protocol/Internet Protocol (TCP/IP) link, a Wireless Application Protocol (WAP) link, or a wireless network link. The wireless network link may include, for example, a global system for mobile (GSM), a code division multiple access (CDMA), CTMTS, General Packet Radio Service (GPRS), Evolution-Data Optimized (EVDO), High-Speed Downlink Packet Access (HSDPA), Worldwide Interoperability for Microwave Access (WiMAX), 2G, 3G, and the like.

Database 210 may contain the business data retrieved from one or more POS systems 102, the subscription details of different users, the contact details such as IP addresses, phone numbers, and the like for different users, the policies and rules for governing the process of POS data management, and the like. The business data in database 210 may be updated regularly using a regular data feed from one or more POS systems 102. This may include updating specific data fields in database 210. Alternatively, the entire business data of database 210 may be updated regularly based on, for example, subscription models of different users, availability of data in one or more POS systems 102, and the like. Examples of the regular interval may include an hour, two hours, a day, and the like. The subscription model may include information such as details of mobile device 106, details of the retail store, data fields to be provided, access privileges of each user, security levels, frequency of automatic updates, preferred format of the data feed, preferred connectivity links, and the like.

Communication link manager 212 in one or more applications servers 104 may be connected to one or more POS systems 102 through a communication link, which may include a Bluetooth connection, an Infra-red connectivity, a Wi-Fi connection, an Internet. Protocol (IP) link, a Transmission Control Protocol (TCP) link, a transmission Control Protocol/Internet Protocol (TCP/IP) link, a Wireless Application Protocol (WAP) link, Global System for Mobile (GSM) link, a Time Division Multiple Access (TDMA) link, a Code Division Multiple Access (CDMA) link, the RS232 standard (serial), and the like.

In accordance with an embodiment of the invention, policy and rules manager 206 in one or more applications servers 104 contains predefined rules for providing selected business data to one or more mobile devices 106 automatically. The predefined rules may include, for example, selected data to be sent at regular intervals, selected data to be sent at a predefined time, selected data to be sent when a particular event occurs, and the like. Rules may also be configured to provide the information such as contact address of mobile device 106, the second format for providing output to mobile device 106, specific data fields to be provided to mobile device 106 based on the subscription, and the like. The contact address of one or more mobile devices 106 may include, for example, IP address of mobile devices 106, phone identification numbers for mobile devices 106, and the like.

In accordance with an embodiment of the invention, policy and rules manager 206 in one or more applications servers 104 may trigger the process for transmitting selected business data to one or more mobile devices 106 when predefined conditions are satisfied. For example, policy and rules manager 206 in one or more applications servers 104 may be configured to trigger an update to be sent to one or more mobile devices 106 when an employee signs in for the day. In this case, the policy and rules manager 206 in one or more applications servers 104 enables regular connection with one or more POS systems 102 to retrieve employee sign-in data. When the retrieved data contains information on signing-in of an employee, an update to the one or more mobile device 106 may be triggered.

Configuration wizard 214 facilitates configuring of the policies and rules within policies and rules manager 206. The configuring may include, for example, defining the policies and rules, storing the policies and rules in database 210 and enabling the execution of policies and rules based on predefined conditions. Examples of the predefined conditions may include regular time internals, predefined time, ad-hoc request from the user, and the like. Further, configuration wizard 214 may be used for feeding details of the subscription models in database 210.

In accordance of an embodiment of the invention, configuration wizard 214 can be hosted on a separate data processing unit. The example of data processing may include, for example, a desktop computer, a laptop, a PDA and the like. The data processing unit may be located within the retail store or may be hosted by a service provider. In accordance with still another embodiment of the invention, configuration wizard 214 may be hosted on mobile device 106. The user may have access rights to define and modify the rules and policies, the subscription model, and the like.

In accordance with an embodiment of the invention, application server 104 may be hosted in the retail store. This may include hosting application server 104 on, for example, POS system 102, a separate data processing unit, and the like. In accordance with another embodiment of the invention, application server 104 may be hosted by a service provider. In such cases, configuration wizard 214 may be operated by the service provider based on requests from each user requesting the services of the service provider and predefined practices.

In accordance with an embodiment of the invention, application server 104 may be hosted on a mobile device, which may be similar to mobile device 106. In accordance with another embodiment of the invention, one or more components of application server 104 may be hosted on the mobile device. For example, mobile content manager 204 may be hosted on mobile device 106 such that mobile content manager 204 converts the request into the first format before mobile device 106 sends the request to one or more application servers 104.

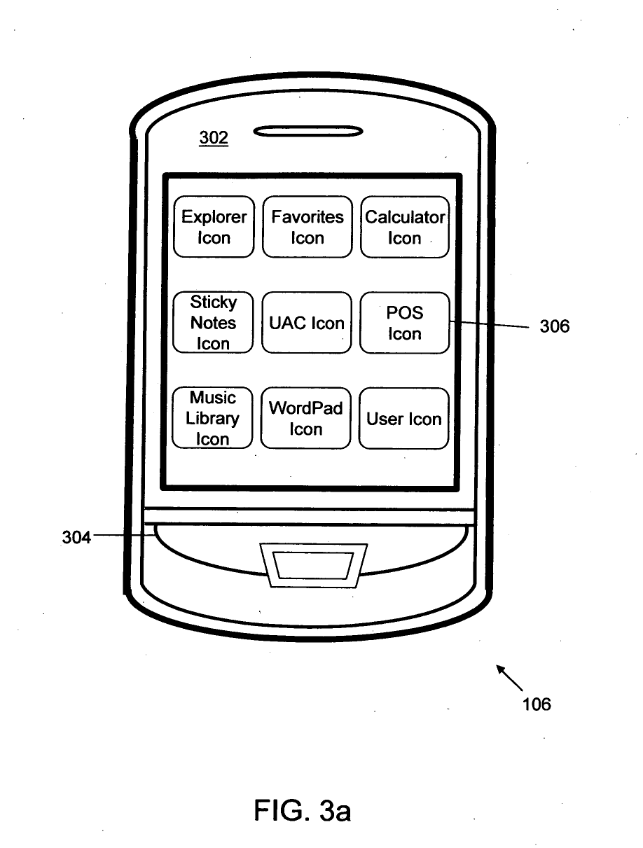

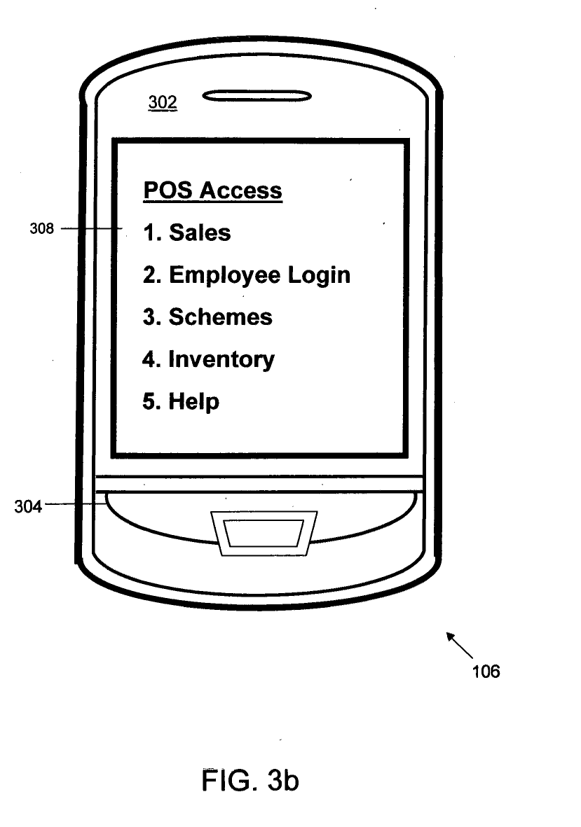

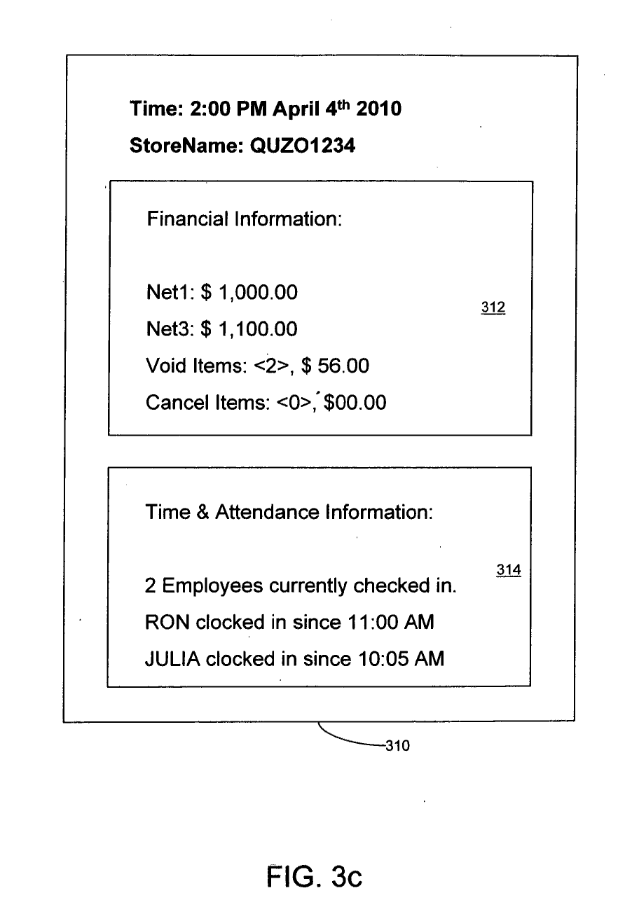

FIG. 3a and FIG. 3b illustrate initiating the request for the business data using one or more mobile devices 106, in accordance with an embodiment of the invention. Mobile device 106 comprises a display unit 302 and a keypad 304.

In accordance with an embodiment of the invention, a POS access application may be configured on one or more mobile devices 106 for initiating the request. The POS access application may be similar to or the same as mobile application 108 explained in conjunction with FIG. 1. As shown in FIG. 3a, the POS access application may be accessed by clicking on an icon 306 displayed on display unit 302 using keypad 304. Icon 306 may be linked to a user interface 308 of FIG. 3b providing a menu of options for creating the request. FIG. 3b illustrates the user interface 308 containing a list of various options for managing and accessing the business data through mobile device 106. The user may select one or more of these options to retrieve the desired data. Examples for the various options may include requesting hourly sales, inventory details, employee log-in details, ongoing schemes, and the like. In accordance with an embodiment of the invention, the user may select the desired option by clicking on the options provided on user interface 308. A request for business data is generated by the POS access application based on the selection of the menu options.

In accordance with various embodiments of the invention, the POS access application may be used to initiate a request for business data in a required format. For example, the POS access application may convert a click on a menu option into a java query which may be processed by application server 104. Further, the POS access application may also facilitate connecting mobile device 106 with application server 104 by, for example, providing the IP address of application server 104, initiating a connection with application server 104 when a menu option is selected, and the like.

In accordance with various embodiments of the invention, the POS access application may be a software application installed on mobile device 106. The application may require an operating system on mobile device 106 to provide a suitable environment for the POS access application to function.

Examples of the operating system may include Symbian, Microsoft Windows Mobile, Android, Blackberry Operating System (OS), iPhone OS, Palm OS, BREW, and the like.

In accordance with another embodiment of the invention, the function of the POS access application may be performed by conventional messaging services such as SMS, MMS, and the like. In such cases, the user may compose a message in a predefined format and communicate the message to one or more application servers 104 for requesting business data. The communication may be performed, for example, by using a wireless connection such as Wi-Fi through a service provider network, and the like.

In accordance with another embodiment of the invention, POS access application may be used to modify the business data of one or more POS systems 102. The modification in the business data may include mobile device 106 sending a message to change a particular business data to application server 104, and application server 104 converting the message to a specified format and initiating the modification of the business data in one or more POS systems 102. Examples of the modification in the business data may include a user using mobile device 106 to change a discount rate on a particular item, a user using mobile device 106 to login or logout of the retail store, a user managing the price of an inventory item, a user using mobile device 106 to manage the login details of employees, and the like.

FIG. 3c is an exemplary screenshot of a user interface 310 for displaying the business data retrieved from one or more POS systems 102. User interface 310 contains a first list box 312 displaying the financial information and a second list box 314 displaying the employee log details. In accordance with an embodiment of the invention, user interface 310 may also provide an option to store the retrieved business data for future reference.

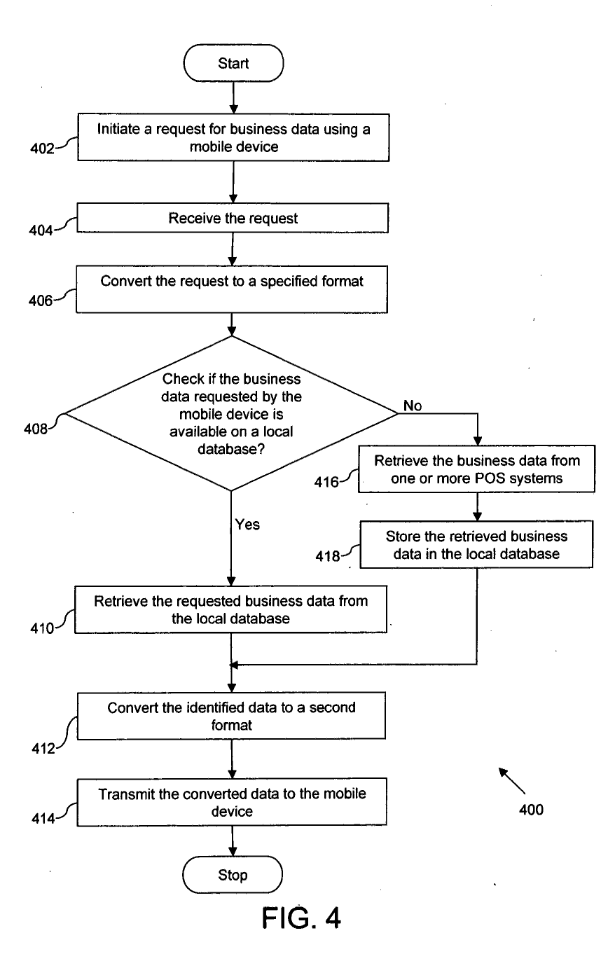

FIG. 4 is a flowchart illustrating a method 400 for providing POS business data to a mobile device, in accordance with an embodiment of the invention. Method 400 is based on providing the business data to the mobile device in response to a request made by mobile device 106. Method 400 may be executed by using a system such as system 100 explained in conjunction with FIG. 1 and FIG. 2.

At step 402, a request for business data is generated through a mobile device. In accordance with an embodiment of the invention, the mobile device may be similar to mobile device 106 and the request may be initiated using various elements of the mobile device as explained in conjunction with FIG. 2 and FIG. 3a and b. At step 404, the request for the business data is received by a mobile device transport server the same or similar to mobile 5 device transport server 202. At step 406, the request is converted to a first format for processing. The first format may be, for example, a text format, a table format, numbers, and the like. At step 408, a check is performed to confirm if the requested business data is available within a local database. The local database may be the same or similar to database 210, and the check may be performed by a module which is the same or similar to database manager 208.

At step 410, the business data is retrieved from the local database if the requested business data is available in the local database. The retrieving may include screening the local database to identify the requested business data and extracting the requested business data fields from the local database based on predefined policies and rules. The predefined policies and rules include, for example, authorizing the request based on the user's subscription model, selecting specific data fields based on the request and the subscription model, and the like. At step 412, the retrieved business data is converted to a second format based on predefined policies and rules. The second format may be, for example, the specific format defined in the subscription model, format defined based on the request, and the like. At step 414, the requested business data is transmitted to the mobile device and may be displayed to the user.

At step 408, if the requested business data is not available at the local database, the requested business data is retrieved from one or more POS systems based on the predefined rules and policies at step 416. At step 418, the business data retrieved from the POS system is stored in the local database for future reference. The retrieved business data may then be converted to the second format at step 412, and transmitted to the mobile device at step 414.

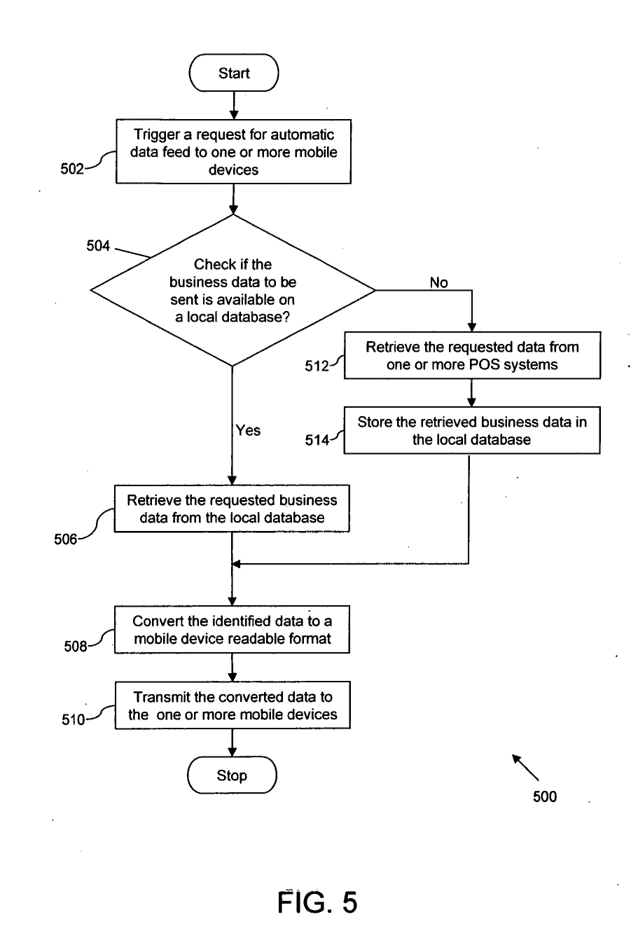

FIG. 5 is a flowchart illustrating a method 500 for providing POS business data to one or more mobile devices, in accordance with another embodiment of the invention. Method 500 is based on the automatic feed of business data to mobile devices such as mobile device 106. Method 500 may be executed by using a system such as system 100 explained in conjunction with FIG. 1, FIG. 2, and FIG. 3a and FIG. 3b.

At step 502, a request for providing an automatic data feed to one or more mobile devices is triggered. In accordance with an embodiment of the invention, the request may be triggered by a policy and rule manager such as policy and rule manager 206 based on predefined rules and policies. The policy and rules manager may also provide information such as the contact details of the mobile device, a predefined second format for transmitting and displaying data on the one or more mobile devices, predefined time for providing the feed, specific data fields to be provided to the mobile device, and the like.

At step 504, a check is performed to identify if the requested business data is available on a local database. The requested business data is retrieved from the local database at step 506 if the requested data is available on the local database. At step 508, the retrieved data may be converted to the second format and transmitted to one or more mobile devices at step 510 using a communication link.

At step 504, if the requested business data is not available at the local database, the requested business data is retrieved from one or more POS systems based on the predefined rules and policies at step 512. At step 514, the business data retrieved from the one or more POS systems is sent to the local database and is stored in the local database for future reference. In accordance with an embodiment of the invention, a copy of the business data retrieved from the one or more POS systems is stored in the local database, and a second copy is converted to the mobile readable format at step 508 and transmitted to the mobile device at step 510. In an embodiment of the present invention, the business data retrieved from the one or more POS systems is stored in the local database after every predefined time interval.

Method 500 may be implemented based on predefined rules. For example, configuration wizard 214 may be used to configure rules that enable an update to be sent to the mobile device about the hourly sales averages every hour. Further, configuration wizard 214 may be used to provide the details of the mobile device, such as the mobile number, when the update needs to be provided. In this case, method 500 is performed every hour to provide hourly averages to the mobile device.

Various components of the systems described above may be implemented in the form of software, a firmware, hardware or combinations thereof.

The systems, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system includes a computer, an input device, and a display unit. The computer can incorporate a microprocessor. The microprocessor can be connected to a communication bus. The computer can also include a memory. The memory may include Random Access Memory (RAM) and/or Read Only Memory (ROM). The computer system can further incorporate a storage device. The storage device can include a hard disk drive or a removable storage drive, such as a floppy disk drive and/or an optical disk drive. The storage device can also be other similar means for loading computer programs or other instructions into the computer system.

The computer system executes a set of instructions that are stored in one or more storage elements in order to process input data. The storage elements may also hold data or other information as required. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine. The system and the components may include, by way of example, software or hardware and/or combinations of software and hardware.

While various embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention.

1. A method for facilitating real time management of a remote Point of Sale (POS) terminal by using a mobile device, the method comprising:
receiving a request for POS data;
retrieving the POS data corresponding to the request from a database;
converting the POS data into a mobile readable data format; and
sending the converted data to the mobile device.

2. The method according to claim 1 further comprising converting the request into a first data format.

3. The method according to claim 1, wherein the request for the POS data is initiated by the mobile device.

4. The method according to claim 1, wherein the request for the POS data is triggered by an application server.

5. The method according to claim 1, wherein the request for the POS data is triggered based on one or more rules.

6. The method according to claim 5, wherein the one or more rules comprise at least one of triggering the request at regular time intervals, triggering the request based on a status of inventory data and triggering the request based on a status of sales data.

7. The method according to claim 1 further comprising:
retrieving the POS data corresponding to the request, wherein the POS data is retrieved from the remote POS terminal; and
storing the retrieved data in the database.

8. The method according to claim 7, wherein the POS data is sent from the POS terminal to the database.

9. The method according to claim 8, wherein the POS data is sent from the POS terminal to the database for all transactions carried out at the POS terminal.

10. The method according to claim 8, wherein the POS data is sent from the POS terminal to the database after every predefined time interval.

11. The method according to claim 1 further comprising authorizing the request for the POS data.

12. A system for facilitating real time management of a remote Point of Sale (POS) terminal by using a mobile device, the system comprising:
a database for storing POS data; and
an application server in communication with the remote POS terminal, the database and the mobile device, the application server comprising:
a mobile device transport server for receiving a request for the POS data;
a database manager for retrieving the POS data corresponding to the request; and
a mobile content manager for converting the retrieved POS data to a mobile readable format and sending it to the mobile device.

13. The system according to claim 12 further comprising a policy and rules manager for retrieving POS data from the database based on one or more rules.

14. The system according to claim 12, wherein the request for the POS data is initiated by the mobile device.

15. The system according to claim 12, wherein the mobile content manager converts the request for the POS data into a first data format.

16. The system according to claim 12, wherein the request for the POS data is triggered by the application server.

17. The system according to claim 12, wherein the request for the POS data is triggered based on one or more rules.

18. The system according to claim 17, wherein the one or more rules comprise at least one of triggering the request at regular time intervals, triggering the request based on a status of inventory data and triggering the request based on a status of sales data.

19. The system according to claim 12 further comprising a configuration wizard for facilitating configuration of one or more rules for retrieving the POS data.

20. The system according to claim 12, wherein the POS data is sent from the POS terminal to the database.

21. The system according to claim 12, wherein the POS data is sent from the POS terminal to the database for all transactions carried out at the POS terminal.

22. The system according to claim 12, wherein the POS data is sent from the POS terminal to the database after every predefined time interval.

23. A storage element that stores a computer program product for use with a computer, the computer program product comprising a computer usable medium having a computer readable program code embodied therein for facilitating real time management of a remote Point of Sale (POS) terminal by using a mobile device, the computer readable program code comprising:
program instructions for receiving a request for POS data;
program instructions for retrieving the POS data corresponding to the request from a database;
program instructions for converting the POS data into a mobile readable data format; and
program instructions for sending the converted data to the mobile device.

24. The storage element according to claim 23 further comprising program instructions for converting the request into a first data format.

25. The storage element according to claim 23 further comprising:
program instructions for retrieving the POS data corresponding to the request, wherein the POS data is retrieved from the remote POS terminal; and
program instructions for storing the retrieved data in the database.

26. The storage element according to claim 23 further comprising program instructions for authorizing the request for the POS data.
